(19) United States
(12) Patent Application Publication
(10) Pub. No.: US 2012/0315426 A1
(43) Pub. Date: Dec. 13, 2012

(54) AUTO-ALIGNING JOINT ARCHITECTURE

(75) Inventor: Don Roy Sauer, San Jose, CA (US)

(73) Assignee: Don Roy Sauer, San Jose, CA (US)

(21) Appl. No.: 13/157,914

(22) Filed: Jun. 10, 2011

(51) Int. Cl. B32B 3/02

(52) U.S. Cl. 428/57

(57) ABSTRACT

The Auto-Aligning Joint Architecture consists of adding endpoint margin regions to sheets which are intended to be joined together. A series of T shaped cuts are made into the margin regions to create alternating connected or disconnected margin regions. The connected margin regions of one sheet align to the disconnected margin regions of the other sheet, such that connected margin regions can fit into disconnected margin regions, thereby joining both sheets together with great precision.

### FIELD OF THE INVENTION

This invention relates joining together of two flexible sheets through the use of a plurality of T shape cuts being made into the two sheets. The cuts made into the sheets create alternating regions where the edge margin region of a sheet is either connected or disconnected to the sheet region. Every uncut region of one sheet is aligned to fit into the cut region of the corresponding sheet, thereby joining both sheets together with great precision.

### BACKGROUND

Joining two flexible sheets together in a curved manner normally requires some type of external clamping means to hold the two sheets together at a set of precise point before the sheets are joined together. FIG. 1 shows the curved shape that sheet segments need to take on in order to build a parabola. Sheet 11 and sheet 12 often need some endpoint margin region such at margin 13 and margin 14 in order to provides some overlapping mean where the joining process will take place. Reference line 15 intersects the margin region of sheet 12 in two places. Precision point 17 is one of the points where sheet 12 needs to be precisely joined to a corresponding precision point in sheet 11. Normally an external clamp means is needed to hold sheets 11 and 12 together at the precision points before the sheets are permanently joined together.

### BRIEF SUMMARY OF THE INVENTION

This invention provides a way to precisely join curved sheets together without needing external clamps. The two sheets are held precisely in place by the overlapping of margin regions. The two sheets are joined together, but not permanently. In some cases such a joint may be enough. The architecture consists of making a series of T shaped cuts into the margin regions of each sheet such that two margin regions can fit and overlap within each other.

### BRIEF DESCRIPTION OF THE DRAWINGS

Non-limiting and non-exhaustive embodiments are described with reference to the following drawings:

FIG. 1 illustrates two sheet segments used to make a parabola.

FIG. 2 illustrates the invention where T shape cuts are made into the margin regions of the two sheets.

FIG. 3 illustrates one method that can be used to overlap the margin regions.

FIG. 4 illustrates how six segments will precisely join together to create a half parabola shape.

FIG. 5 illustrates another overlapping method which works well for globes.

FIG. 6 illustrates the overlapping method of FIG. 6 where slot cuts instead of T shaped cuts are made in one of the sheets.

### DETAILED DESCRIPTION OF THE PREFERRED EMBODIMENT

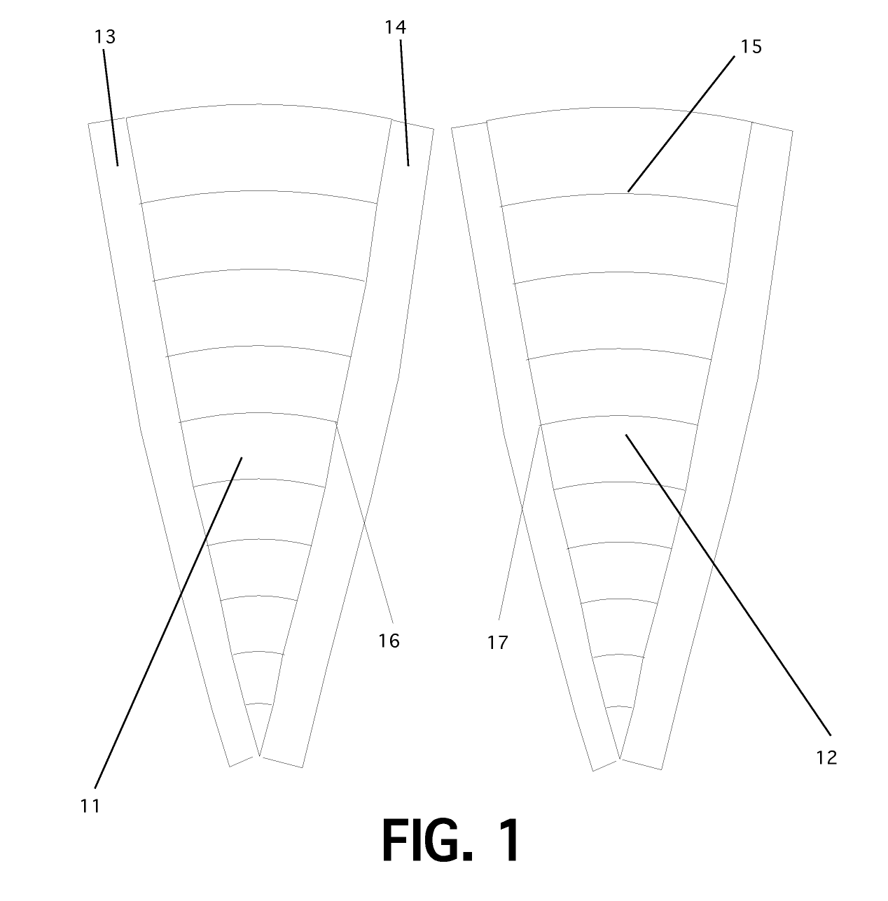

Joining two flexible sheets together in a curved manner normally requires some type of external clamping means to hold the two sheets together at a set of precise points before the sheets are joined together. FIG. 1 shows the curved shape that 12 sheet segments need to take on in order to build a parabola. Sheet 11 and sheet 12 often need some endpoint margin region such at margin 13 and margin 14 in order to provides some overlapping means where the joining process will take place. Reference line 15 intersects the margin region of sheet 12 in two places. Precision point 17 is one such point where sheet 12 needs to be precisely joined to a corresponding precision point in sheet 11.

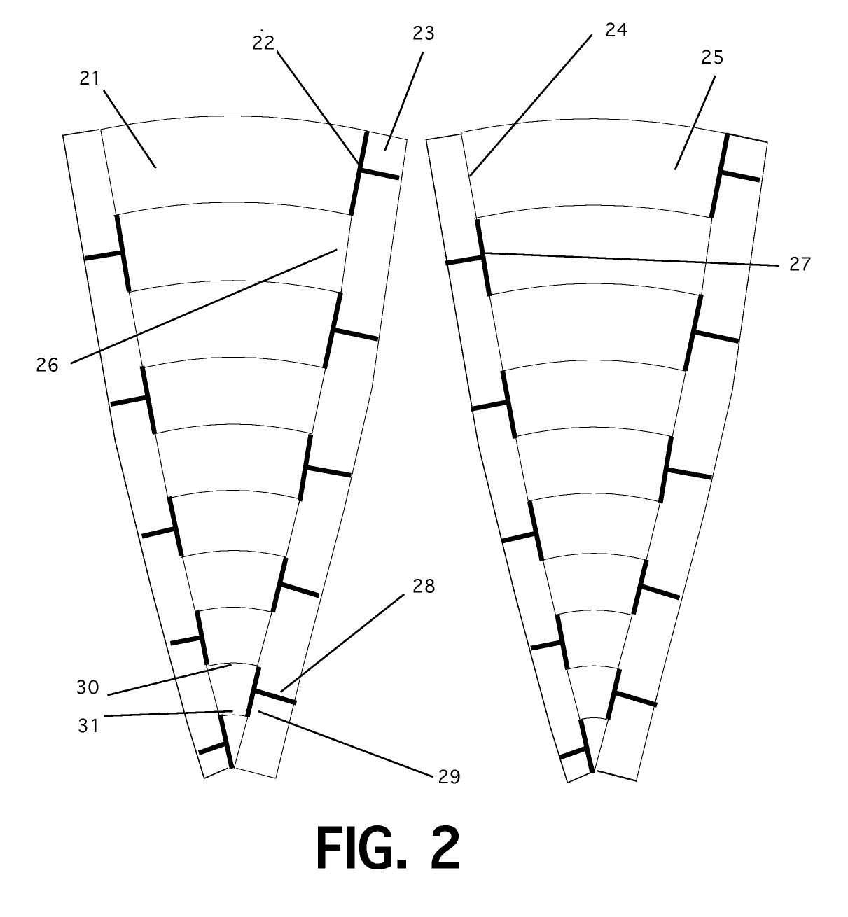

Sheets 21 and 25 of FIG. 2 shows the invention consists of making a series of slot cuts like T shaped cut 23 into the margins region 23. The T shape cuts create a series of cut and uncut regions in margins region 23. An uncut region 26 in sheet 21 is made to align perfectly to cut region 27 of sheet 25. Precision point 29 is where reference line 31 runs into margin region 23. For T shaped cut 28, the top of the T is made precisely between where reference lines 31 and 30 intersect margin region 23. All such cuts in either sheet 21 or sheet 25 either begin or end at a precision point like precision point 29. The cross cut 20 forms the stem of the T. This cross cut can be enlarged if necessary. This cross cut allows cut region 27 of sheet 25 to be opened up to create a much larger hole in order to accept uncut region 26 from sheet 21.

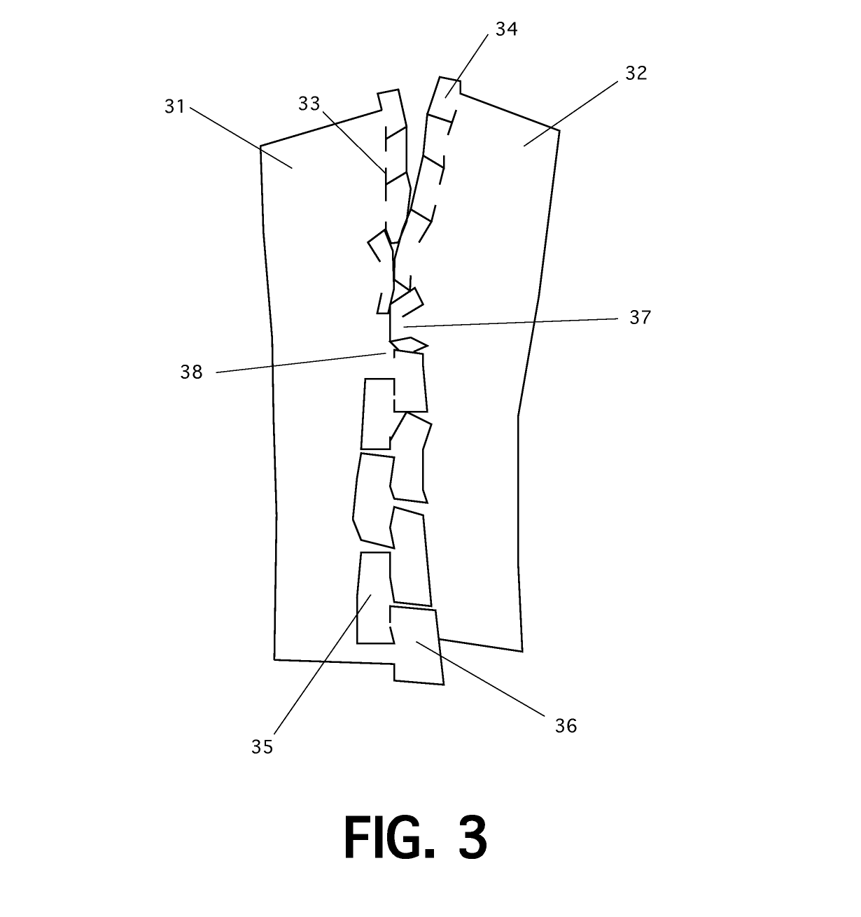

FIG. 3 shows one method to overlap the margin regions 35 and 36 of sheets 31 and 32. Since sheets 31 and 32 must be flexible in order to form a curved shape, uncut region 37 can fit between the cut region 38. This method works like a zipper in that the alternate uncut regions are fitted into cut regions for both sheets.

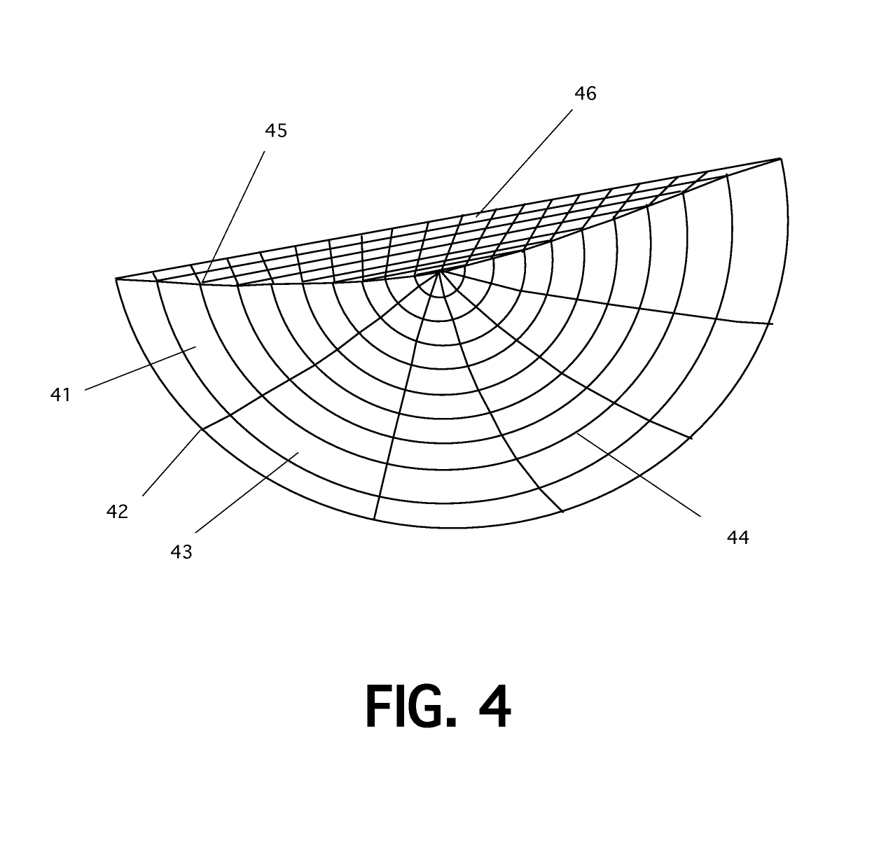

If uncut regions are made to precisely fit into cut regions, all sheets will be bound together at all precision points. FIG. 4 shows that six segments such as sheet 41 create the half parabola 43. Lines like reference line 44 will line up perfectly with all the other reference lines on all the other sheets. To sanity check the 3D structure, parabola graph 46 was added. This parabola was designed to fit a y=a*x̂2 equation. The reference lines are spaced at equal units of x. How well all reference lines match up to both x and y lines of a parabola graph is a good test.

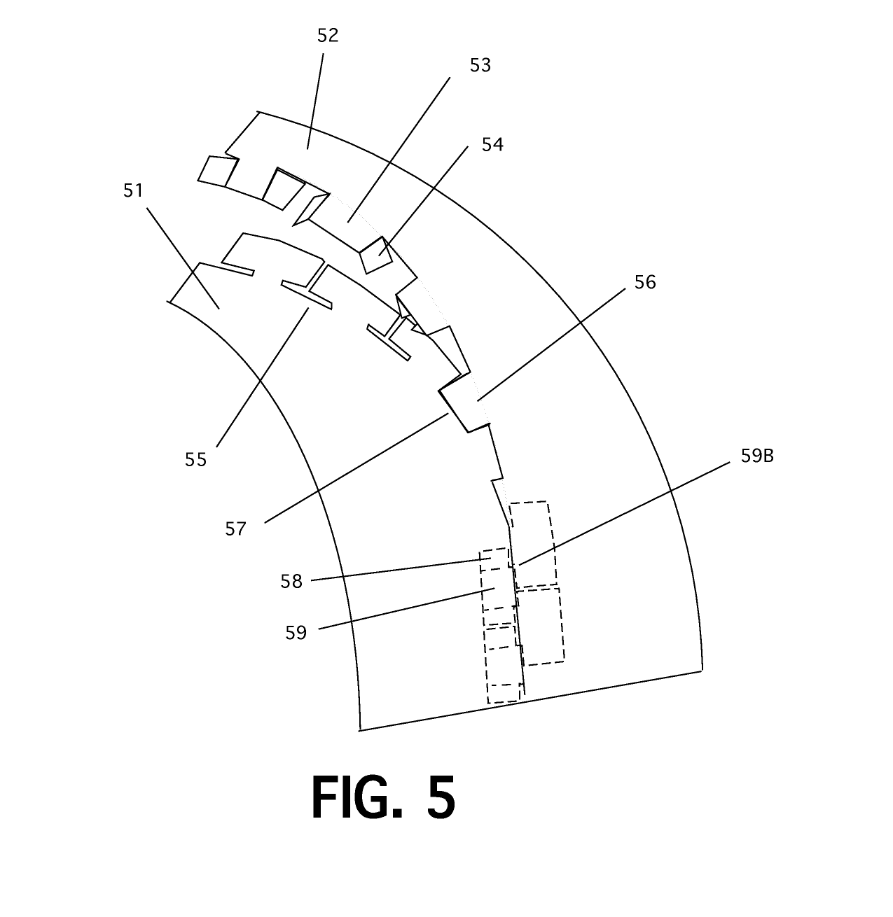

The overlapping process shown in FIG. 3 may not be optimum for all applications. FIG. 5 shows that the globe application is connecting the segments together while both segments 51 and 52 are bent. Bending tabs like tab 54 to go under tab 53 of segment 53 seems to work well. When both tabs of 53 are bent in, tab 53 will easily slide into T shape opening 55 on segment 51. Tab 54 is shown half way in hole 57. When tab 59 is completely inside hole 59B, tabs like tab 58 can be unfolded. Doing so firmly joins segments 51 and 52 together.

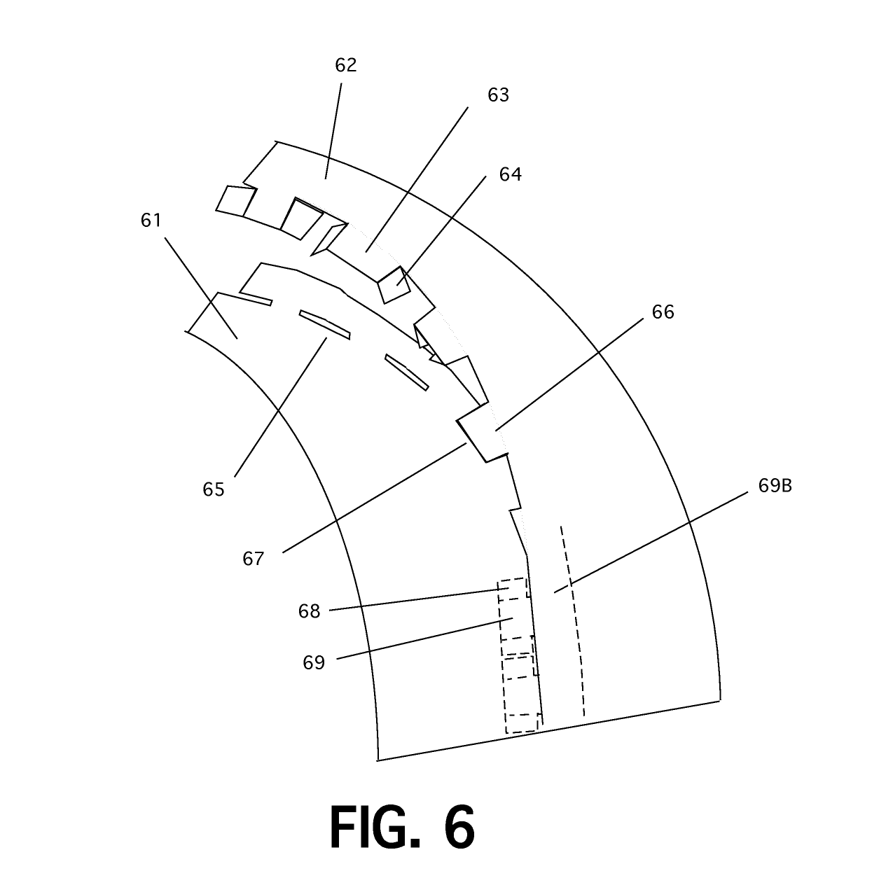

The use of T shaped cuts on both margin regions is often desirable, but not a requirement. FIG. 6 shows the method used in FIG. 5 where cut 65 is a slot rather than a T cut. This might make the fitting of tabs like tab 66 into slot cut 67 a little more difficult. Using T shaped cuts on both sides is the preferred embodiment.

The invention may or may not require a further joining method to make the joint more permanent. Being nonpermanent has some advantages in terms of being able to put something together and later take it apart. The join is flexible between the two sheets. The joint is somewhat like a cardboard box that can be folded flat.

While the invention has been shown in this particular embodiment, it will be understood by those skilled in the art, that different methods of making a T shape cut will also work. The stem part of the T cut can be make much larger, as long as there is enough overlap of the margin regions to hold the sheets together. The stem part of the T cut may not necessarily be on both sides of the joint. The cut and uncut regions can be made any length as long as the alignment for mutual fitting is maintained. More than one sheet can be made to overlap an join to another sheet. All of these substitutions can all be made with out departing from the spirit and scope of the invention.

What is claimed is:

1. An architecture to join a plurality of sheets, comprising:
a first region sheet having at least a first edge margin region connected to at least one edge of the said first region sheet; and
containing a plurality of alternating slot cuts aligned and located along the border of said first region sheet and said first edge margin region; and
a next region sheet having at least a next edge margin region connected to at least one edge of the said next region sheet; and
containing a next plurality of alternating slot cuts aligned and located along the border of said next region sheet and said next edge margin region; and
comprising a plurality of slot to margin edge cross cuts existing across the said next region sheet, separating the said next region sheet into an alternating set of margin connected to sheet regions as well as an alternating set of margin disconnected slot regions; and
the said plurality of alternating slot cuts are complementary aligned between said first region sheet and said next region sheet; such that
said plurality of alternating slot cuts can receive the corresponding said alternating set of margin connected to sheet regions of the said next region sheet into the said first region sheet; whereby
both said first region sheet and said next region sheet become precisely interlocked together.

2. An architecture to join a plurality of sheets, comprising:
a first region sheet having at least a first edge margin region connected to at least one edge of the said first region sheet; and
containing a plurality of alternating slot cuts aligned and located along the border of said first region sheet and said first edge margin region; and
a next region sheet having at least a next edge margin region connected to at least one edge of the said next region sheet; and
containing a next plurality of alternating slot cuts aligned and located along the border of said next region sheet and said next edge margin region; and
comprising a plurality of slot to margin edge cross cuts existing across an aligned set of margin regions, separating the said aligned set of margin regions into an alternating set of margin connected to sheet regions as well as an alternating set of margin disconnected slot regions; and
the said plurality of alternating slot cuts are complementary aligned between said first region sheet and said next region sheet; such that
said alternating set of margin disconnected slot regions can receive the corresponding said alternating set of margin connected to sheet regions of the said first region sheet into the said next region sheet and likewise the said next region sheet into the said first region sheet; whereby
both said first region sheet and said next region sheet become precisely interlocked together.

3. An architecture to join a plurality of sheets, comprising:
a first sheet having a first edge margin region containing a plurality of T shaped cuts; and
said plurality of T shaped cuts are oriented to cut a local plurality of slot regions between said first sheet and said first edge margin region; and
said plurality of T shaped cuts are spaced apart to create a plurality of alternating cut and uncut regions between said first sheet and said first edge margin region; and
a stem region of each said local T shaped cut consisting of a plurality of full length cuts from the center of said local plurality of slot regions across said first edge margin region; and
a second sheet having a second edge margin region containing the said plurality of T shaped cuts; and
said plurality of T shaped cuts are oriented to cut the said local plurality of slot regions between said second sheet and said second edge margin region; and
said plurality of T shaped cuts are spaced apart to create the said plurality of alternating cut and uncut regions between said second sheet and said second edge margin region; and
the said stem region of each said local T shaped cut consists of the said plurality of full length cuts from the center of said top T region to said margin edge of said second edge margin region; and
corresponding said plurality of alternating cut and uncut regions on said second sheet are aligned and spaced apart; such that
a localized uncut regions in said second sheet fits within a corresponding cut regions in said first sheet; and
the said localized uncut regions in the said first sheet are aligned to fit within said corresponding cut regions in said second sheet; such that
said localized uncut regions for said first sheet and said second sheet are fitted within said corresponding cut regions for the corresponding said second sheet and said first sheet; such that
said first edge margin region overlaps the said second sheet and said second edge margin region overlaps the said first sheet; and
said first sheet and said second edge margin region and said second sheet and said first edge margin region being fitted within each other; whereby
said first sheet and said second sheet are precisely joined together.

4. An architecture to join a plurality of sheets of claim 1, wherein
said plurality of slot to margin edge cross cuts have been expanded to create a plurality of margin region opening across the said next region sheet.

5. An architecture to join a plurality of sheets of claim 1, wherein
said plurality of slot to margin edge cross cuts have been expanded to create a plurality of margin region opening across the said first edge margin region and next edge margin region.

6. An architecture to join a plurality of sheets of claim 1, wherein said plurality of full length cuts have been expanded to create a plurality of margin region opening across the said first edge margin region and said next edge margin region.
